(19) United States
(12) Patent Application Publication
(10) Pub. No.: US 2017/0100728 A1
(43) Pub. Date: Apr. 13, 2017

(54) SWITCHABLE SHOWERHEAD

(71) Applicant: BESTTER(XIAMEN) TECHNOLOGY INC., Xiamen City (CN)

(72) Inventors: Binhua GONG, Xiamen City (CN); Jianbo HE, Xiamen City (CN); Mengshi GUO, Xiamen City (CN); Chaojian LIN, Xiamen City (CN)

(73) Assignee: BESTTER(XIAMEN) TECHNOLOGY INC., Xiamen City (CN)

(21) Appl. No.: 15/268,009

(22) Filed: Sep. 16, 2016

(30) Foreign Application Priority Data
Oct. 9, 2015 (CN) 201510647828.0

(51) Int. Cl. B05B 1/16; B05B 12/00; B05B 15/06; B05B 1/18

(52) U.S. Cl. CPC B05B 1/1681; B05B 1/18; B05B 12/002; B05B 15/061

(57) ABSTRACT

A switchable shower head includes a waterway device and a waterway switch device that has at least two outlet functions. The waterway switch device has a water diversion plate that can rotate to switch the outlet function. The waterway switch device includes a ratchet wheel, which is coaxially connected to the water diversion plate; a transmission rack, which is disposed to the waterway device and is capable of moving away or closing to the ratchet wheel, the transmission rack is reset by two or more than two elastic elements; a transmission element, which is slidably assembled to the transmission rack and is capable of abutting against the ratchet of the ratchet wheel to move the ratchet wheel to rotate, an angle is formed between the sliding direction of the transmission element and the sliding direction of the transmission rack; and a driving mechanism.

### FIELD OF THE INVENTION

The present invention relates to sanitary wares, especially to a shower head with a plurality of switchable outlet functions.

### BACKGROUND OF THE INVENTION

Existing shower heads in the market mostly apply with a switch dial button to switch the outlet functions to achieve varies outlet functions such as massage water, rotating water, etc, but the switch device is unstable, and it has short service time. The switch dial button is usually disposed at the joint portion of the handle and the main body, when used, the dial button is dialed to switch the outlet functions. However, this kind of switch method has disadvantage, if the switch position is close, a person can use a single hand to dial, but if it is far away, a person must use both hands to use, it is not convenient enough to operate.

### SUMMARY OF THE INVENTION

The present invention is provided with a switchable shower head to solve the existing problem.

The technical proposal of the present invention is that:

A switchable shower head, comprises a waterway device and a waterway switch device, the waterway device comprises at least two outlet functions, wherein the waterway switch device comprises:

a water diversion plate disposed in the waterway, when rotating the water diversion plate, the outlet is switched to different outlet functions;

a ratchet wheel, which is coaxially connected to the water diversion plate;

a transmission rack, which is disposed to the waterway device and is capable of moving away and closing to the ratchet wheel, the transmission rack is reset by two or more than two elastic elements;

a transmission element, which is slidably assembled to the transmission rack and is capable of abutting against the ratchet of the ratchet wheel to move the ratchet wheel to rotate, an angle is formed between the sliding direction of the transmission element and the sliding direction of the transmission rack.

And a driving mechanism is further provided, the driving mechanism comprises a press button and a driving means assembled between the press button and the transmission rack.

In another preferred embodiment of the present invention, the transmission rack is limited by a sliding limit mechanism to slide forth and block in one direction.

In another preferred embodiment, the angle between the moving direction of the transmission rack and the sliding direction of the transmission element is 30-150 degrees. Preferred 90 degrees.

In another preferred embodiment, the central portion of the transmission rack is disposed with a sliding cavity and a fixing shaft, the transmission element is sleeved on the fixing shaft, a third reset spring is disposed between the transmission element and the side wall of the sliding cavity, the transmission element compresses the third reset spring when sliding to abut against the ratchet wheel.

In another preferred embodiment, the left and right end of the transmission rack is disposed with a transmission rack first reset spring and a second reset spring.

In another preferred embodiment, the waterway device further comprises a reset rack, the reset rack is fixed to the waterway device to correspond to the transmission rack, a spring flapper is further configured, the left and right end of the transmission rack is respectively disposed with a first reset spring and a second reset spring, one end of the first reset spring and the second reset spring is disposed to the transmission rack, the other end is disposed to the spring flapper.

In another preferred embodiment, the waterway device comprises a cover plate component, one side of the cover plate component is disposed with a plurality of inlet holes, the other side is disposed with a plurality of outlet holes, different inlet hole or different combination of the inlet holes corresponds to different set of outlet holes to form different outlet function; when the water diversion plate rotates, the outlet holes of the water diversion plate correspond to the inlet hole or the combination of the inlet holes of the cover plate component.

In another preferred embodiment, a fixing seat is disposed at the upper portion of the cover plate component, the fixing seat comprises a main body, an extending section and a rear section, the bottom portion of the extending section is disposed with a pendulum fixing column, the extending section is disposed with an elongated through hole in the left-right direction, the left end of the elongated through hole is disposed with an elongated guide groove to the left; a button fixing column is disposed at the transition area of the extending section and the rear section.

In another preferred embodiment, the transmission element comprises a pendulum and a sliding block, one end of the pendulum is pivoted to the pendulum fixing column at the bottom portion of the fixing seat, the other end is a free end passing through the elongated through hole, one side of the free end abuts against the side of the sliding block; one end of the press button is fixed to the button fixing column at the bottom portion of the fixing seat, the other end abuts against the other side of the free end of the pendulum.

As can be seen from above, the present invention has advantages as follows:

1. The present invention is applied with a driving mechanism to rotate the ratchet wheel, pressing the press button can achieve the switch, a person can use one hand to operate, it is convenient to use.

2. The driving mechanism comprises the transmission rack and the transmission element, both are slidably coupled to drive the ratchet to rotate, it is applied with a reset spring to reset, this structure has long service life.

3. The transmission element comprises the pendulum and the sliding block, making it with small size and simple structure.

### BRIEF DESCRIPTION OF THE DRAWINGS

FIG. 1 illustrates an exploded and schematic diagram of the pressing switch shower head of the first embodiment.

FIG. 2A illustrates a sectional diagram of the first embodiment before the switch.

FIG. 2B illustrates a sectional diagram of the first embodiment after the switch.

FIG. 3A illustrates a sectional diagram of the first embodiment from another view angle before the pressing.

FIG. 3B illustrates a sectional diagram of the first embodiment from another view angle after the pressing.

FIG. 4 illustrates a schematic diagram of the fixing seat of the first embodiment.

FIG. 5 illustrates a bottom view of the fixing seat of the first embodiment,

FIG. 6 illustrates a sectional diagram of the transmission rack of the first embodiment.

FIG. 7 illustrates a schematic diagram of the transmission element of the first embodiment.

FIG. 8 illustrates a sectional diagram of the combination of the transmission rack and the transmission element of the first embodiment.

FIG. 9 illustrates a schematic diagram of the combination of the transmission rack and the transmission element of the first embodiment,

FIG. 10 illustrates an exploded and schematic diagram of the press button switch shower head of the second embodiment,

FIG. 11A illustrates a sectional diagram of the second embodiment before the switch.

FIG. 11B illustrates a sectional diagram of the second embodiment after the switch.

FIG. 12A illustrates a sectional diagram of the second embodiment from another view angle before the press.

FIG. 12B illustrates a sectional diagram of the second embodiment from another view angle after the press.

FIG. 13 illustrates a schematic diagram of the fixing seat of the second embodiment,

FIG. 14 illustrates a schematic diagram of the steel wire unit of the second embodiment.

FIG. 15 illustrates a schematic diagram of the press button of the second embodiment.

FIG. 16 illustrates a schematic diagram of the wire clasp of the second embodiment.

FIG. 17 illustrates a schematic diagram of the pull rod of the second embodiment.

FIG. 18 illustrates a schematic diagram of the reset rack of the second embodiment.
Reference signs: lower body 1,
cover plate component 2, inlet ring 2-1, inlet hole 2-2, outlet hole 2-3, screw fixing column 2-4,
special-shaped ring 3,
water diversion plate 4, water diversion hole 4-1, water diversion plate shaft hole 4-2,
taper spring 5,
fixing seat 6, main body 6-1, extension section 6-2, rear section 6-3, screw hole 6-4, central through hole 6-5, stop pawl fixing seat 6-6, sliding strip 6-7, elongated through hole 6-8, guide groove 6-9, press button fixing column 6-10, press button fixing shaft hole 6-11, pendulum fixing column 6-12, outlet chamber 6-13,
stop pawl 7, synchronous shaft 8, ratchet wheel 9, Y-shaped ring 10, reset rack 11, first and section reset spring A 12, transmission element 13, upper body 14, third reset spring B 15,
transmission rack 16, sliding chamber 16-1, transmission element fixing shaft hole 16-2, spring fixing column 16-3, spring chamber 16-4,
sliding block 17, transmission fixing shaft 18, pendulum 19, pendulum fixing shaft 20, shaft 21, press button 22, press button fixing shaft 23.

### DETAILED DESCRIPTION OF THE EMBODIMENTS

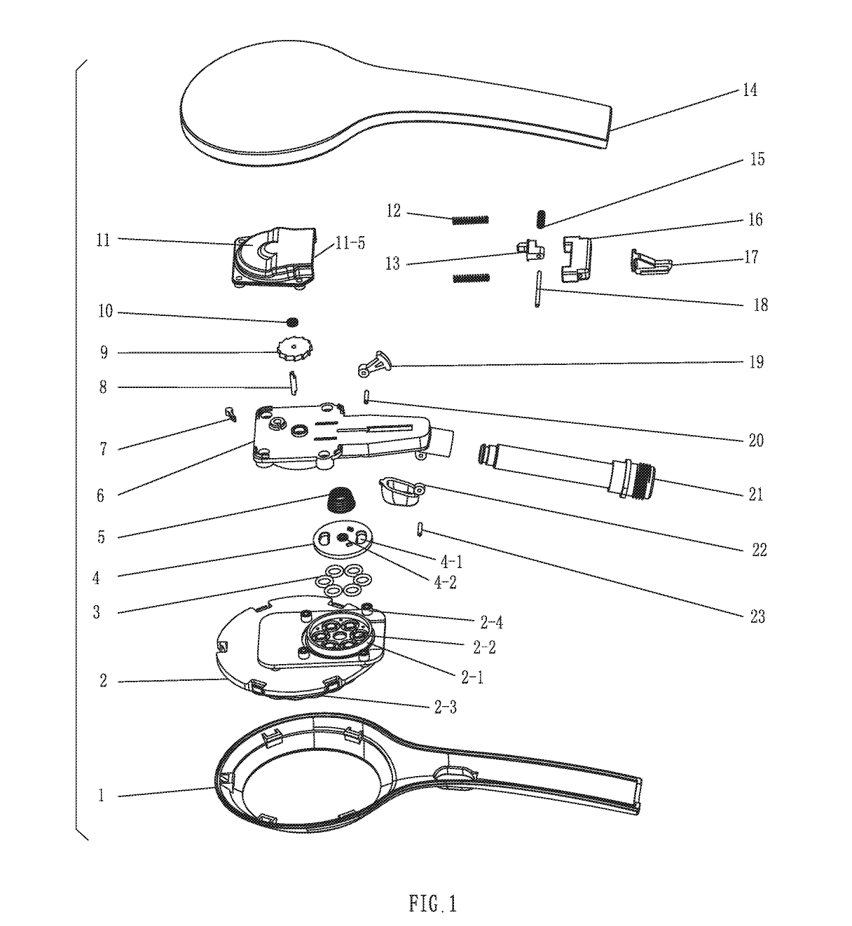

The first embodiment of the present invention, referring to FIGS. 1-9, is a press button switch shower head, which comprises a waterway device and a waterway switch device.

Referring to FIG. 1, the waterway device comprises a lower body 1 and an upper body 14. The upper and the lower body are respectively disposed with an upper handle and a lower handle, a shaft 21 having inlet function is disposed between the upper handle and the lower handle.

A cover plate component 2 is embedded in the main body of the lower body 14, the rear side of the cover plate component 2 is disposed with an inlet ring 2-1, the inlet ring 2-1 is disposed with a plurality of inlet holes 2-2 annularly arranged, each inlet hole 2-2 is disposed with a special-shaped ring 3 for sealing, the sealing rings 3 are fixedly connected to form an annular structure; the front side of the cover plate component 2 is disposed with a plurality of outlet holes 2-3, which are divided to different outlet function sets, different inlet hole 2-2 (of different combination of the inlet holes) corresponds to different set of outlet holes 2-3 so as to form different outlet function. There are 2-4 outlet functions as needed, or more than 4. A water diversion plate 4 is disposed in the inlet ring 2-1 above the inlet holes 2-2, a pair of water diversion holes 4-1 are disposed at the water diversion plate symmetrically. When the water diversion plate rotates, the water diversion holes 4-1 are corresponding to different inlet holes 2-2 or the combination to switch the outlet functions. The center of the water diversion plate 4 is disposed with a non-circle plate shaft hole 4-2, in this embodiment, the section of which is semi-circle, to rotate the water diversion plate 4. Other shapes are available in other embodiments, such as triangle, rectangle and other non-circle shape.

A fixing seat 6 is disposed above the water diversion plate, a taper spring 5 is disposed between the fixing seat 6 and the water diversion plate 4, the taper spring 5 is used to press the water diversion plate and to provide preload compensation to the sealing ring when in low water pressure.

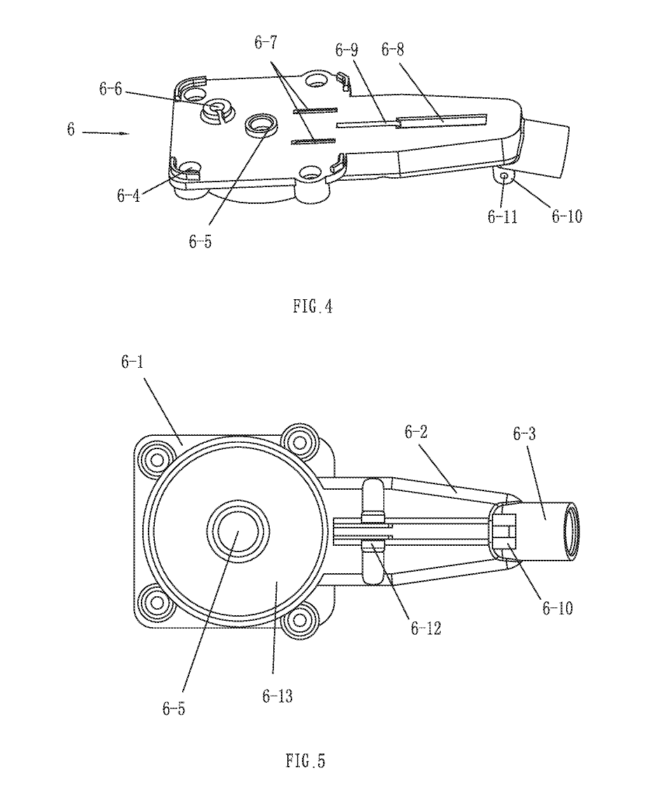

Referring to FIG. 4, the fixing seat 6 comprises a main body 6-1, an extending section 6-2 and a rear section 6-3 from left to right, the right end of the rear section 6-3 is disposed with an inlet, which is connected to the outlet of the shaft 21. The bottom of the main body 6-1 is disposed with an outlet chamber 6-13. Four corners of the main body 6-1 are respectively disposed with a screw hole 6-4, the center of the main body 6-1 is disposed with a central through hole 6-5, on the upper surface of the main body 6-1, a stop pawl fixing seat 6-6 is disposed between the central through hole 6-5 and the screw hole 6-4 at the left upper corner. Two left-right sliding strips 6-7 are disposed parallel between the right upper and the right lower screw holes 6-4. The bottom portion of the extending section 6-2 is disposed with a pendulum fixing column 6-12, which is disposed with a pendulum fixing shaft hole. A left-right elongated through hole 6-8 is disposed in the extending section 6-2, the left end of the elongated through hole 6-8 is disposed with an elongated guide groove 6-9. the transition area of the extending section 6-2 and the rear section 6-3 is disposed with a press button fixing column 6-10, which is disposed with a press button fixing shaft hole 6-11.

The waterway switch device comprises a ratchet wheel 9, the water diversion plate, a transmission mechanism and a driving mechanism, the water diversion plate has been described above. The ratchet wheel 9 is assembled to the center of the upper surface of the fixing seat 6, a synchronous shaft 8 is disposed between the ratchet wheel 9 and the water diversion plate 4, so that the ratchet wheel 9 and the water diversion plate 4 rotate synchronously. Two ends of the synchronous shaft 8 are non-circle shape that they are respectively inserted to the non-circle shaft hole of the ratchet wheel 9 and the water diversion plate 4.

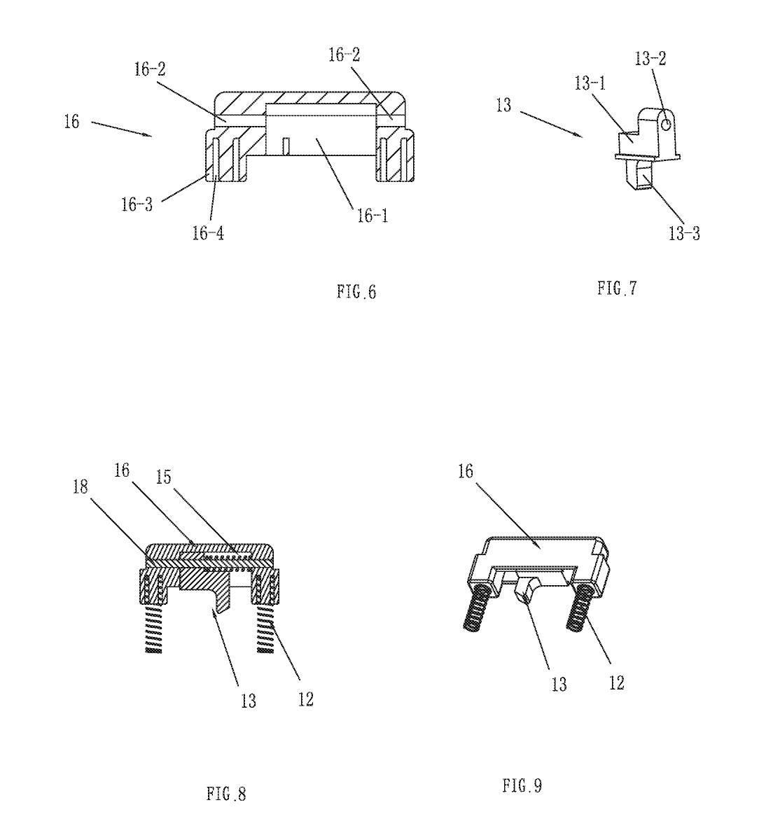

Referring to FIG. 6, the transmission mechanism comprises a transmission element 13 and a transmission rack 16, the later one is generally cuboid, the central portion of the transmission rack 16 is concaved inwardly with a sliding chamber 16-1, the left and right side of the sliding chamber 16-1 are respectively disposed with a transmission element fixing hole 16-2, the transmission element 13 is assembled to the sliding chamber 16-1 by the transmission element fixing shaft 18. the left and right end of the transmission rack 16 are respectively protruding to one side with a spring fixing column 16-3, which is disposed inside with a spring chamber 16-4 and a first and a second reset spring 12.

Referring to FIG. 7, the transmission element 13 comprises a pivot portion 13-1 and a transmission portion 13-3, the pivot portion 13-1 is disposed with a shaft hole 13-2. The transmission element 13 is fixed into the sliding chamber 16-1 of the transmission rack 16 by the transmission element fixing shaft 18, the transmission element 13 can slide left and right along the transmission element fixing shaft 18 in the sliding chamber 16-1. A third reset spring 15 is sleeved on the transmission element fixing shaft 18 between the transmission element 13 and the inner side wall of the transmission rack.

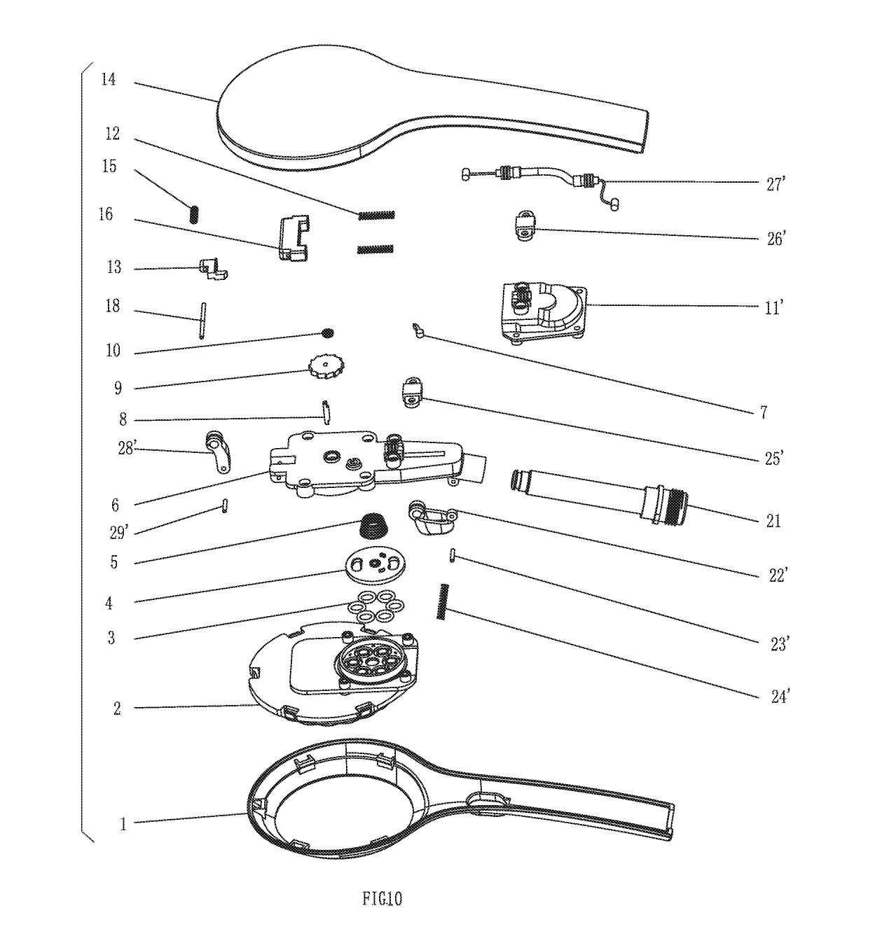

Referring to FIG. 9, the driving mechanism comprises a press button 22, a pendulum 19 and a sliding block 17, the sliding block 17 is assembled to the guide groove 6-9 to slide along the guide groove 6-9 and limited. One end of the pendulum is pivoted to the pendulum fixing column 6-12 at the bottom of the fixing seat, the other end is a free end passing through the elongated through hole 6-8, one side surface of the free end abuts against the side surface of the sliding block 17; one end of the press button 22 is fixed to the press button fixing column 6-10 at the bottom of the fixing seat, the other end abuts against the other side surface of the free end of the pendulum.

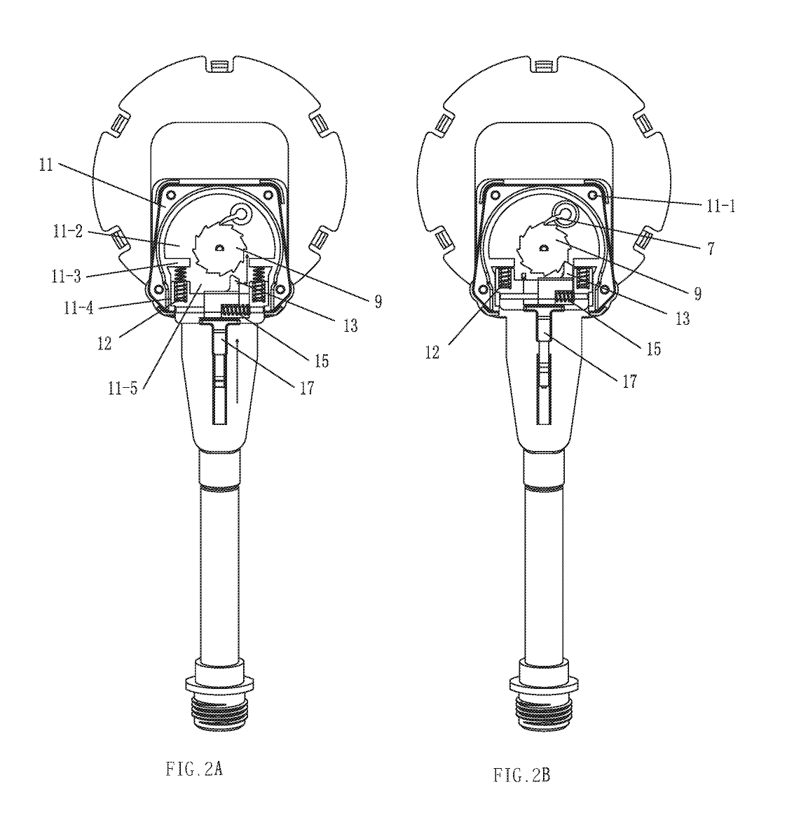

Referring to FIG. 2A and FIG. 2B, the waterway switch device further comprises a reset rack 11, which is generally rectangle, four corners are respectively disposed with screw hole 11-1 corresponding to the screw hole 6-4 of the fixing seat 6, the bottom portion is disposed with a receiving chamber 11-2, the lower side of the receiving chamber 11-2 is disposed with an opening 11-5, the left and right side of the central portion are disposed with a spring flapper 11-3, the lower portion of the spring flapper 11-3 is disposed with a limit portion 11-4, the transmission rack 16 enters the opening 11-5 and slides up and down along the limit portion 11-4.

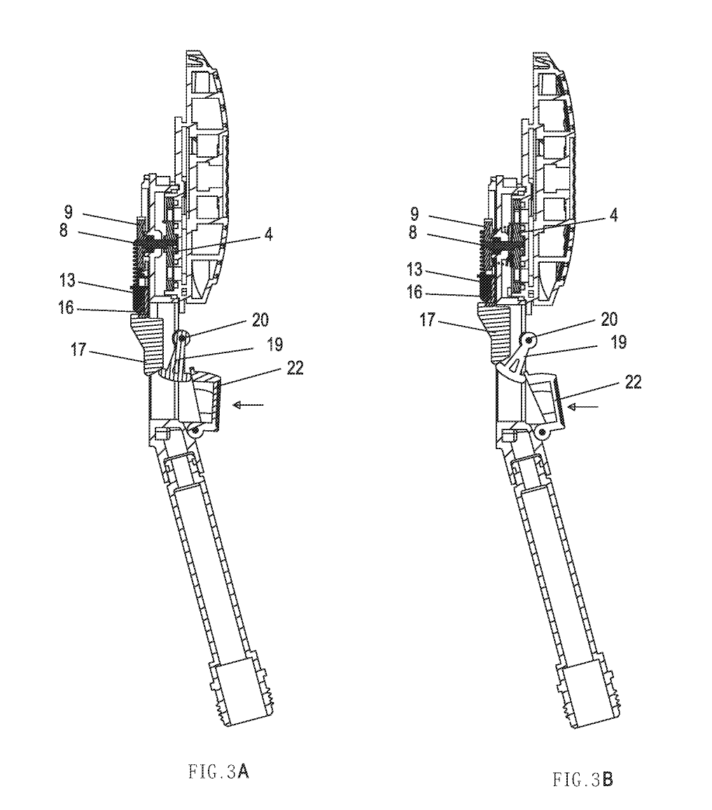

The present invention is used as described hereafter, referring to FIG. 2A, FIG. 2B and FIG. 3A, FIG. 3B:

Pressing the press button 22 to make the press button 22 rotate about the button fixing shaft 23 in the press button fixing shaft hole 6-11, the free end of the button 22 pushes the free end of the pendulum; the free end of the pendulum 19 rotates about the pendulum fixing shaft 20 in the pendulum fixing column 6-12 to push the sliding block 17 to slide up along the guide groove 6-9; The sliding block 17 pushes the transmission rack 16 to move up, so that the end of the transmission element 13 in the transmission rack 16 is contacted with the ratchet of the ratchet wheel to push the ratchet wheel to rotate in the counter-clockwise direction, during this proceed, the transmission element 13 slides to the right in the transmission rack 16, the third reset spring 15 is compressed; during the transmission rack 1 moving up, as the spring flapper 11-3 limits, the first and second reset springs 12 are compressed as well;

The ratchet wheel 9 rotates to drive the water diversion plate 4 to rotate synchronously, the water diversion hole 4-1 of the water diversion plate 4 changes its position to align with other inlet hole 2-2 or the combination to achieve the switch of the outlet function. The stop pawl 7 abuts against the ratchet wheel to prevent the ratchet wheel from rotating reversely.

Release the press button 22, under the action of the first and second reset springs 12 and the third reset spring 15, the transmission rack 16 resets downwardly, the transmission rack 13 resets to the left, with the transmission rack 16 resets downwardly, the sliding block 17, the pendulum 19 and the press button 22 reset one by one.

### The Second Embodiment

Referring to FIGS. 14-17, the driving mechanism of this embodiment comprises a press button 22′, two wire clasps 25′, a steel wire unit 27′ and the driving rod 28′. As figured in FIG. 16, the wire clasp 25′ comprises a fixing cover 25′-1 in the central, two sides of the fixing cover 25′-1 are disposed respectively with an extending portion 25′-2, each of which is disposed with a screw hole 25′-3, the lower surface of the fixing cover 25′-1 is disposed with a groove 25′-4 with section shape semi-circle. One of the wire clasps is fixed to the fixing seat 6′, the other one is fixed to the reset rack 11.

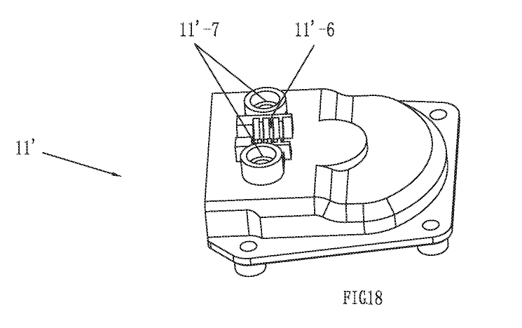

As figured in FIG. 17, the pull rod 28′ comprises a fixing end 28′-1 and a connecting end 28′-2, the fixing end 28′-1 is fixed to the pull rod fixing portion 6′-14 of the fixing seat 6′ by the pull rod fixing shaft 29′. The connecting end 28′-2 is disposed with a still wire opening 28′-3.

As figured in FIG. 15, the press button 22′ comprises a button cap 22′-1, one end of the bottom of which is disposed with a pivot portion 22′-2, the other end (free end) is disposed with a connecting portion 22′-3, the connecting portion 22′-3 is disposed with a wire groove 22′-4.

As figured in FIG. 14, the steel wire unit comprises a steel wire 27′-1, the central section of the steel wire 27′-1 is disposed with a sleeve 27′-2, two ends of the sleeve are respectively disposed with a fixing portion 27′-3, one of the fixing portion 27′-3 is locked between the groove of the wire clasp of the fixing seat 6′ and the steel wire fixing groove, the other fixing portion 27′-3 is locked in the steel wire fixing groove 11′-6 of the reset rack 11. Two ends of the steel wire 27′-1 are respectively disposed with a limit column 27′-4, one is locked to the rear side of the wire groove 22′-4 of the press button 22′, the other one is locked to the connecting end 28′-2 of the pull rod.

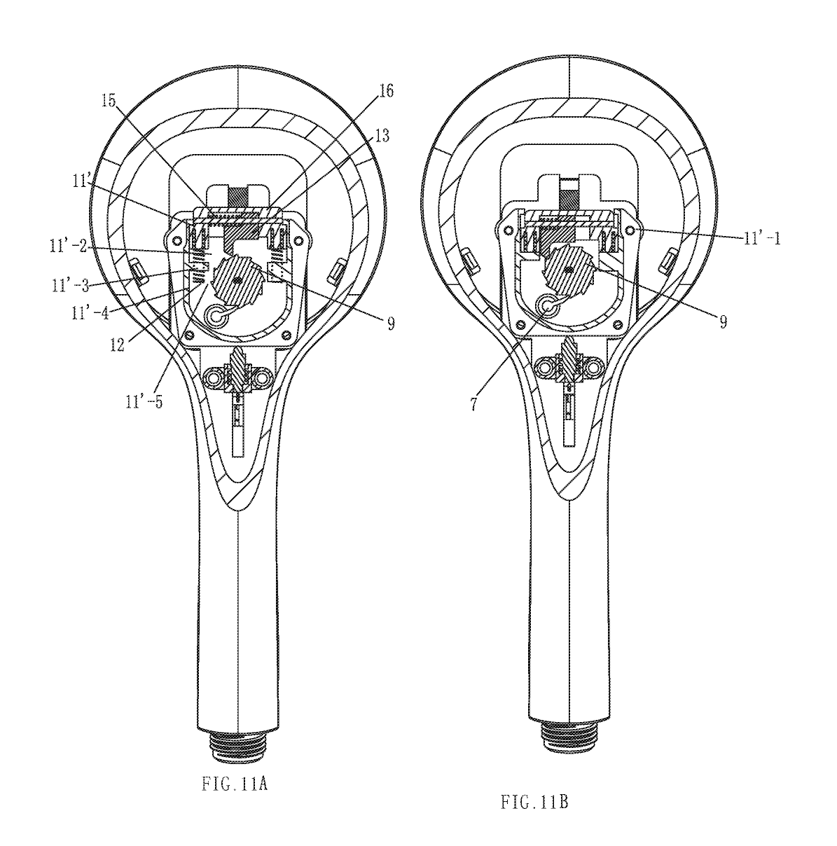

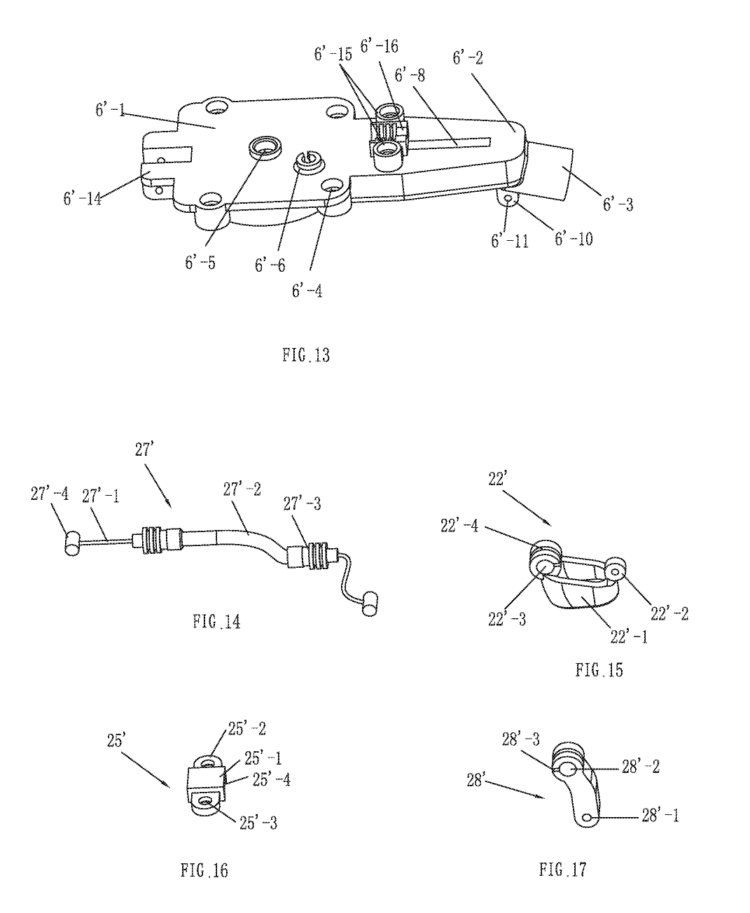

Referring to FIG. 10, FIG. 11, FIG. 13A, FIG. 13B and FIG. 18, the waterway switch device further comprises a reset rack 11′, which is generally square shaped, four corners respectively disposed with a screw fixing hole 11′-1 corresponding to the screw fixing hole 6-4 of the fixing seat 6, the bottom portion is disposed with an accommodating chamber 11′-2, the lower portion of the accommodating chamber is disposed with an opening 11′-5, the left and right sides of the center portion are respectively disposed with a spring flapper 11′-3, the lower portion of the spring flapper 11′-3 is disposed with a limit portion 11′-4, the transmission rack 16 enters from the opening 11′-5 and slides up and down along the limit portion 11′-4. The top surface of the reset rack 11′ is disposed with two wire clasp fixing columns 11′-7 a steel wire fixing groove 11′-6 is disposed between the two wire clasp fixing columns.

The present invention is used as described hereafter:

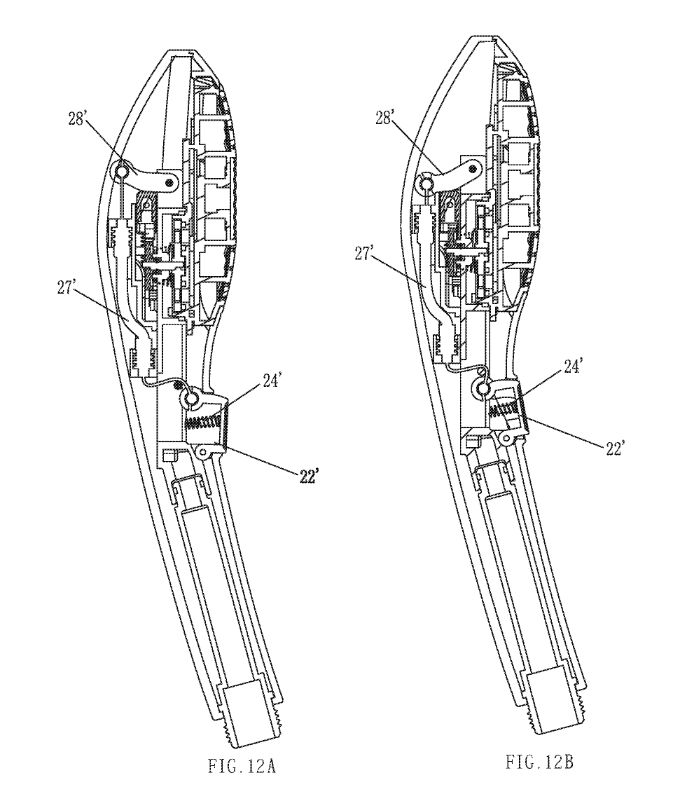

As figured in FIG. 12A and FIG. 12B, pressing the press button 22′ to make the press button 22′ rotate about the button fixing shaft 23′ in the press button fixing shaft hole 6′-11, the free end of the button 22′ rotates, one end of the steel wire unit 27′ is pulled down; so that it drives the connecting section of the pull rod 28′ at the other side of the steel wire unit 28′ to move downwardly. As the fixing end of the pull rod 28′ keeps still, the pull rod 28′ drives the transmission rack 16 contacted with the pull rod 28′ to move downwardly.

As figured in FIG. 11A and FIG. 11B, the transmission portion 11-3 at the end of the transmission element 13 in the transmission rack 16 is contacted with the ratchet of the ratchet wheel 9, the transmission portion 13-3 drives the ratchet wheel to rotate in the counter-clockwise direction, during this proceed, the transmission element 13 slides to the left in the transmission rack 16, the reset spring 15 is compressed; during the transmission rack 1 moving down, as the spring flapper 11-3 limits, two reset springs 12 are compressed as well; The ratchet wheel 9 rotates to drive the water diversion plate 4 to rotate synchronously, the water diversion hole 4 of the water diversion plate 4 changes its position to align with other inlet hole 2 or the combination to achieve the switch of the outlet function. The stop pawl 7 abuts against the ratchet wheel to prevent the ratchet wheel from rotating reversely.

As figured in FIG. 12A and FIG. 12B, release the press button 22′, under the action of the reset springs 12, 15, the transmission rack 16 resets upwardly, the transmission rack 13 resets to the right, with the transmission rack 16 resets upwardly, the steel wire unit 27′, the pull rod 28′ and the press button 22′ reset one by one.

Above mentioned are detailed embodiments of the present invention, but the present invention is not limited, for example, the limit rack 11 can be integrated to the upper body 14 or the fixing rack, the receiving chamber of the transmission rack 16 can be a sliding groove, although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

1. A switchable shower head, comprises a waterway device and a waterway switch device, the waterway device comprises at least two outlet functions, wherein the waterway switch device comprises:
a water diversion plate disposed in the waterway, when rotating the water diversion plate, the outlet is switched to different outlet functions;
a ratchet wheel, which is coaxially connected to the water diversion plate;
a transmission rack, which is disposed to the waterway device and is capable of moving away and closing to the ratchet wheel, the transmission rack is reset by two or more than two elastic elements;
a transmission element, which is slidably assembled to the transmission rack and is capable of abutting against the ratchet of the ratchet wheel to move the ratchet wheel to rotate, an angle is formed between the sliding direction of the transmission element and the sliding direction of the transmission rack.

2. The switchable shower head according to claim 1, wherein a driving mechanism is further provided, the driving mechanism comprises a press button and a driving means assembled between the press button and the transmission rack.

3. The switchable shower head according to claim 1, wherein the angle between the moving direction of the transmission rack and the sliding direction of the transmission element is 30-150 degrees.

4. The switchable shower head according to claim 1, wherein the central portion of the transmission rack is disposed with a sliding cavity and a fixing shaft, the transmission element is sleeved on the fixing shaft, a third reset spring is disposed between the transmission element and the side wall of the sliding cavity, the transmission element compresses the third reset spring when sliding to abut against the ratchet wheel.

5. The switchable shower head according to claim 1, wherein the waterway device further comprises a reset rack, the reset rack is fixed to the waterway device to correspond to the transmission rack, a spring flapper is further configured, the left and right end of the transmission rack is respectively disposed with a first reset spring and a second reset spring, one end of the first reset spring and the second reset spring is disposed to the transmission rack, the other end is disposed to the spring flapper.

6. The switchable shower head according to claim 1, wherein the waterway device comprises a cover plate component, one side of the cover plate component is disposed with a plurality of inlet holes, the other side is disposed with a plurality of outlet holes, different inlet hole or different combination of the inlet holes corresponds to different set of outlet holes to form different outlet function; when the water diversion plate rotates, the outlet holes of the water diversion plate correspond to the inlet hole or the combination of the inlet holes of the cover plate component.

7. The switchable shower head according to claim 6, wherein a fixing seat is disposed at the upper portion of the cover plate component, the fixing seat comprises a main body, an extending section and a rear section, the bottom portion of the extending section is disposed with a pendulum fixing column, the extending section is disposed with an elongated through hole in the left-right direction, the left end of the elongated through hole is disposed with an elongated guide groove to the left; a button fixing column is disposed at the transition area of the extending section and the rear section.

8. The switchable shower head according to claim 7, wherein the transmission element comprises a pendulum and a sliding block, one end of the pendulum is pivoted to the pendulum fixing column at the bottom portion of the fixing seat, the other end is a free end passing through the elongated through hole, one side of the free end abuts against the side of the sliding block; one end of the press button is fixed to the button fixing column at the bottom portion of the fixing seat, the other end abuts against the other side of the free end of the pendulum.

9. The switchable shower head according to claim 1, wherein the shower head further comprises a driving mechanism, the driving mechanism comprises a press button, a steel wire unit and a pull rod, the steel wire unit is connected to the press button and the pull rod, the pull rod drives the transmission rack.

10. The switchable shower head according to claim 9, wherein the press button is disposed at the waterway of the shower head.

11. The switchable shower head according to claim 9, wherein the press button is disposed to the water pipe.

12. The switchable shower head according to claim 2, wherein the angle between the moving direction of the transmission rack and the sliding direction of the transmission element is 30-150 degrees.
